(19) United States
(12) Patent Application Publication
(10) Pub. No.: US 2012/0290211 A1
(43) Pub. Date: Nov. 15, 2012

(54) SYSTEM AND METHOD FOR DETERMINING PROPERTIES OF A HYDROCARBON RESERVOIR BASED ON PRODUCTION DATA

(75) Inventors: Janet Murphy, Sugar Land, TX (US); Christopher Ainley, Vallejo, CA (US)

(73) Assignee: Chevron U.S.A. Inc., San Ramon, CA (US)

(21) Appl. No.: 13/464,133

(22) Filed: May 4, 2012

Related U.S. Application Data
(60) Provisional application No. 61/518,700, filed on May 9, 2011.

(51) Int. Cl. G06F 19/00

(52) U.S. Cl. 702/13

(57) ABSTRACT

A system and computer-implemented method for determining properties of a hydrocarbon reservoir from production data is disclosed. The method includes obtaining production data for a plurality of wells in the hydrocarbon reservoir, arranging the production data for each of the wells such that the production data is indexed in three dimensions, displaying the arranged production data in a three dimensional graphical space to create displayed 3D production data, determining properties of the hydrocarbon reservoir based on the displayed 3D production data, and managing the hydrocarbon reservoir based on the properties of the hydrocarbon reservoir.

### CROSS REFERENCE TO RELATED APPLICATIONS

This application claims priority to U.S. patent application Ser. No. 61/518,700 with a filing date of May 9, 2011.

### FIELD OF THE INVENTION

The present invention relates generally to methods and systems for determining properties of a hydrocarbon reservoir based on production data, and in particular methods and systems for interpreting well production data by displaying the data in a 3 dimensional space including a time or pseudo-depth axis.

### BACKGROUND OF THE INVENTION

As hydrocarbon fields mature, reservoir engineers record large amounts of production data for each well. There may be hundreds or even thousands of wells in a hydrocarbon field and the production data may span decades. Proper management of the field requires interpretation of the production data.

Production data contains information about the fluids produced from the wells or injected in the wells in a hydrocarbon field. This data can be used by one skilled in the art to make decisions about infill well placement, injection wells (gas, water or steam), well shut-ins, and other important reservoir or field management options. For the purposes of this document, the term production data is meant to encompass data related to both fluids produced (i.e., fluids that come out of the well and the rock formations surrounding the well) and fluids injected (i.e., fluids that are forced into the well and the rock formations surrounding the well). Fluids produced may include water and/or hydrocarbons such as natural gas and/or oil. Fluids injected may include water, steam, hydrocarbon gases, and/or CO₂. These examples are not meant to be limiting nor to require all of these. In order to understand the production data, it is generally plotted by a computer.

Typically, production data plots display changes in production and injection data versus time for individual wells or for the total field without regard to the spatial location of the wells, such as the graph in FIG. 1. FIG. 1 shows the cumulative barrels over an entire field of water injected 11, water produced 12, gas produced 13, oil produced 14, and gas injected 15. Pie charts such as example 21 in FIG. 2, bubble plots such as example 31 in FIG. 3, and contoured maps of production data from small time periods (one to several months of data) convey spatial differences across the field at the mapped time interval but do not convey the temporal information. For conventional production data plots, three dimensional data (X, Y, and time) are routinely compressed into the above mentioned two dimensional plots with the resultant loss of information and insight into the behavior of the field.

### SUMMARY OF THE INVENTION

According to one implementation of the present invention, a computer-implemented method of managing a hydrocarbon reservoir is disclosed. The method includes obtaining production data for a plurality of wells in the hydrocarbon reservoir, arranging the production data for each of the wells such that the production data is indexed in three dimensions, displaying the arranged production data in a three dimensional graphical space to create displayed 3D production data, determining properties of the hydrocarbon reservoir based on interpretations of the displayed 3D production data, and managing the hydrocarbon reservoir based on the properties of the hydrocarbon reservoir.

In another embodiment, the displayed 3D production data may be displayed as lathe displays and/or ladder displays. The lathe displays and/or ladder displays may be combined with bubble plots. The 3D data may further be converted into a log signature plot to be overlain on a map.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

These and other features of the present invention will become better understood with regard to the following description, pending claims and accompanying drawings where:

FIG. 1 is a graph showing a prior art display of well production data, in this case the cumulative barrels produced or injected over time for the entire field for different fluids produced and injected;

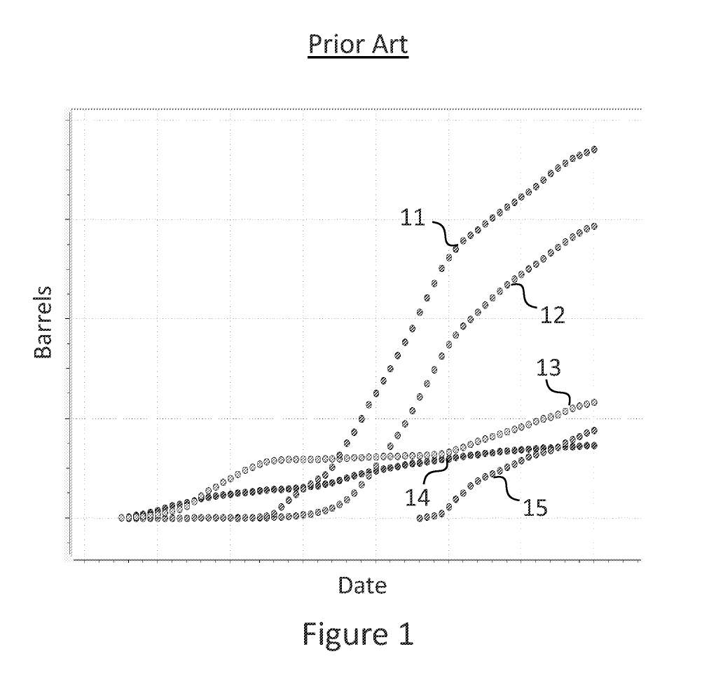

FIG. 2 is a prior art pie chart diagram showing proportionate volumes of fluids produced at each well for a particular time interval;

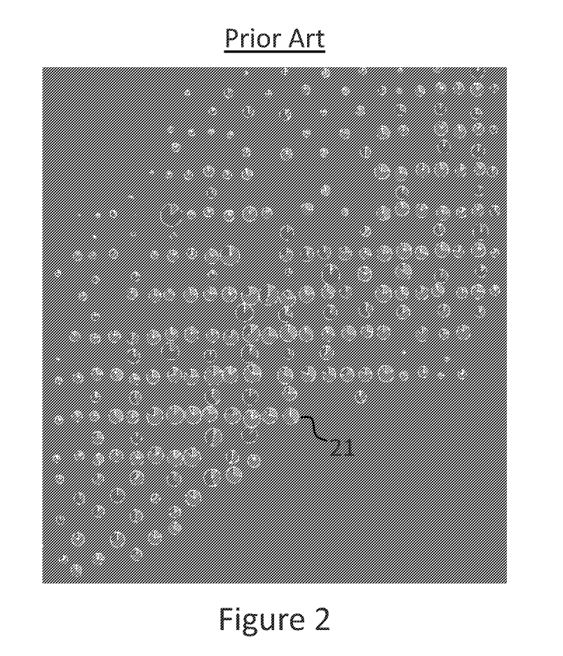

FIG. 3 is a prior art bubble plot diagram;

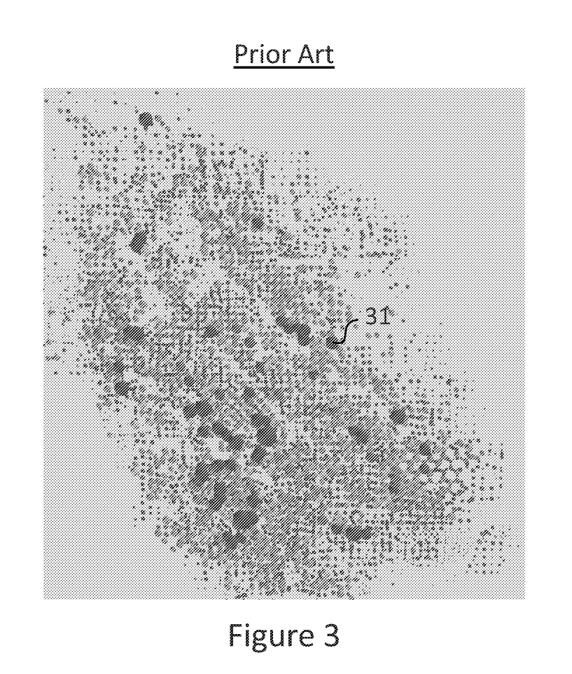

FIG. 4 is a flowchart illustrating a method in accordance with an embodiment of the invention;

FIG. 5 illustrates lathe and ladder diagrams of well production and injection data in a 3D plot;

FIG. 6 illustrates 3D well production data with bubble plots;

FIG. 7 illustrates 3D well production and injection data overlain on a contour map including interpreted faults;

FIG. 8 illustrates 3D well production data which has been converted to a production attribute known as a GOR (Gas Oil Ratio); and

FIG. 9 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to reservoir or field management and, by way of example and not limitation, interpretation of well production data in a 3D (X, Y, time or pseudo-depth) graphical display. Arranging and displaying well production data in 3D allows geoscientists and field engineers to quickly assess field wide trends and inter-well relationships. Inter-well relationships can be indications of reservoir properties such as porosity, permeability, or fluid saturation. Inter-well relationships can also indicate fault properties such as transmissibility. The inter-well relationships may also include assessments of infill well performance, which may be interpreted to provide information on connectivity of the hydrocarbon reservoir in the area of the infill wells. Viewing the well production data in 3D can also highlight the impact of field management decisions, for example and not limitation, injection, infill drilling, and workovers, on the field performance. The ability to analyze well production data in both space and time will aid in reservoir or field management decisions.

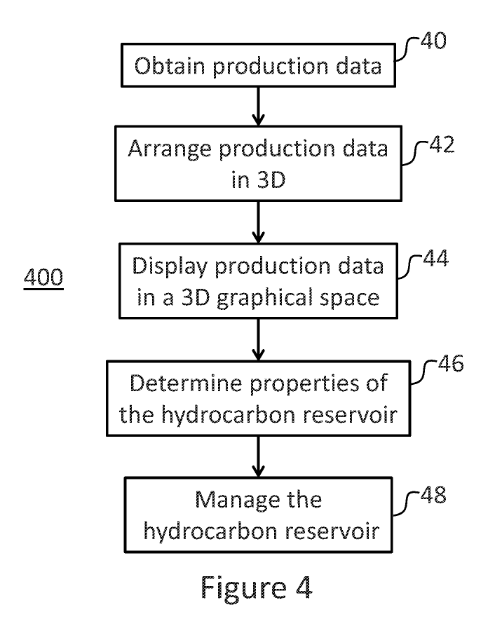

In this regard, an example of a method 400 in accordance with the present invention is illustrated in the flowchart of FIG. 4. At step 40, well production data is received. In an embodiment, the well production data comprises water production, gas production, and oil production data. In another embodiment, the well production data may comprise water injection, gas injection, or steam injection data. In yet another embodiment, the well production data may include any combination of one or more of water production, gas production, oil production, water injection, gas injection, and steam injection data. As can be appreciated, there are many additional types of well production data that may be useful for interpretation and management of the hydrocarbon field and the above examples are not meant to limit the data that may be used or to require that the listed well production data types be used.

The well production data may be in many formats, by way of example and not limitation, the standard .pab file format. This format may include data in time or in time and spatial location. At step 42, the data is arranged in 3 dimensions. These dimensions include two spatial dimensions (for example, X and Y) and one time or pseudo-depth dimension (T or Z). If the well production data does not include the X and/or Y dimensions, it may be obtained from another file containing the needed information, such as a well group file that lists all of the wells with their spatial coordinates. The pseudo-depth dimension may be created by converting the time axis of the production data into spatial rather than temporal units. Markers indicating significant production and injection periods, including but not limited to primary production, water injection, infill production drilling, infill injection drilling, and gas injection, may be added to the time or pseudo-depth axis. The markers may be used to subdivide the production and injection data into time intervals relevant to the history of the field. Step 42 may also include calculations of further production attributes such as water to oil ratio (WOR), gas to oil ratio (GOR), watercut, oilcut, water-cycling and the like.

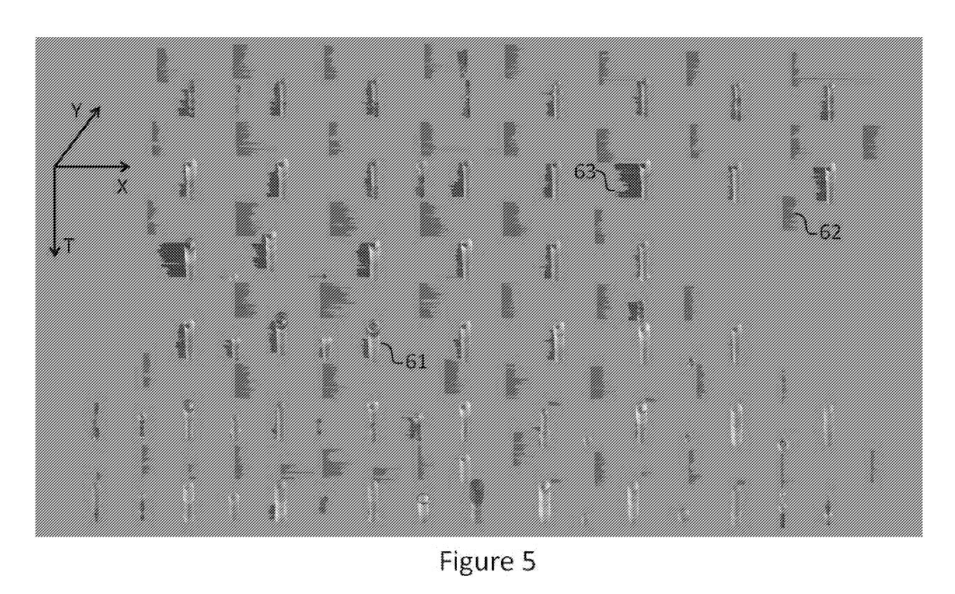

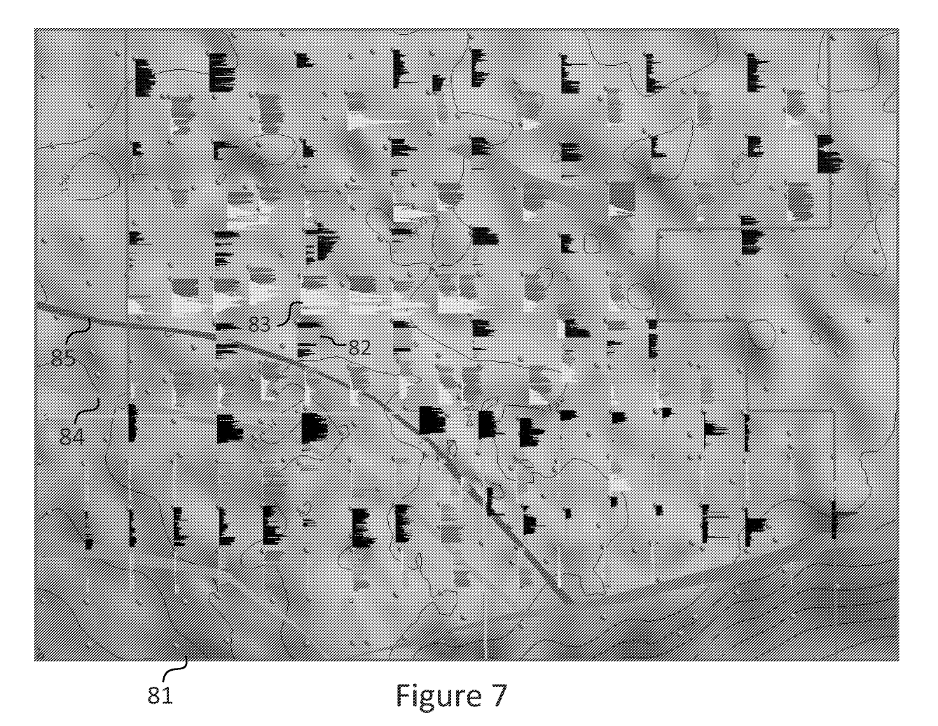

After the desired well production data and production attributes are arranged in 3D, the data can then be displayed via a computer in a 3D graphical space at step 44. These displays may look like the display in FIG. 5. In FIG. 5, well production data for many wells are displayed. This display shows lathe displays such as 61 and ladder displays such as 62. Lathe displays may use both color, including grayscale, and changing diameters to indicate changes in the produced volumes along the time or pseudo-depth axis. Ladder displays may use both color, including grayscale, and the length of the bars to indicate changes in the produced or injected volumes along the time or pseudo-depth axis. By using different colors and by displaying the ladder bars on the left or the right side of the well location, multiple production and injection volumes (oil, water, gas, water injected, and gas injected) can be shown on the same display in their correct spatial position. In FIG. 5, the left-facing dark ladder display such as 63 associated with the colored lathe display represents the water produced. The lighter right-facing ladder displays such as 62 may represent the water injected in the various parts of the field during that time period. The visual assessment of the relationship between the injected fluids and the produced fluids helps determine the interwell connectivity in the field and whether or not faults are leaking or sealing. Wells with anomalous high water production may be associated with fault or fracture systems. Production wells which do not respond to injection (i.e. they do not see an increase in the production rate or they do not produce any of the injected gas or fluids) may indicate separation from the injector wells by means of a sealing fault. FIG. 7 shows production data, arranged in a 3D space, that has been converted into a flat plot (commonly known as a log signature plot) to facilitate the display of the data on maps such as a contour map 81. Gas shown in green such as 82 has been injected in several wells on the north side of the fault. Gas production shown in yellow such as 83 has been observed in several of the wells on the northern side of the fault 85. Little gas has been produced on the southern side of the fault 85, though the wells are spatially located about the same distance from the injectors as the wells on the north side of the fault that were making large amounts of gas. This may indicate that fault 85 is partially sealing. No gas has been produced south of fault 84, which may indicate that fault 84 is fully sealing. These observations allow interpretation that a fault may be sealing or at least acting as a barrier to flow. These examples of colors and orientations of ladder bars are not intended to be limiting. Any use of color, grayscale, varying ladder bar length, varying lathe diameter, and orientation of the displays falls within the scope of this invention.

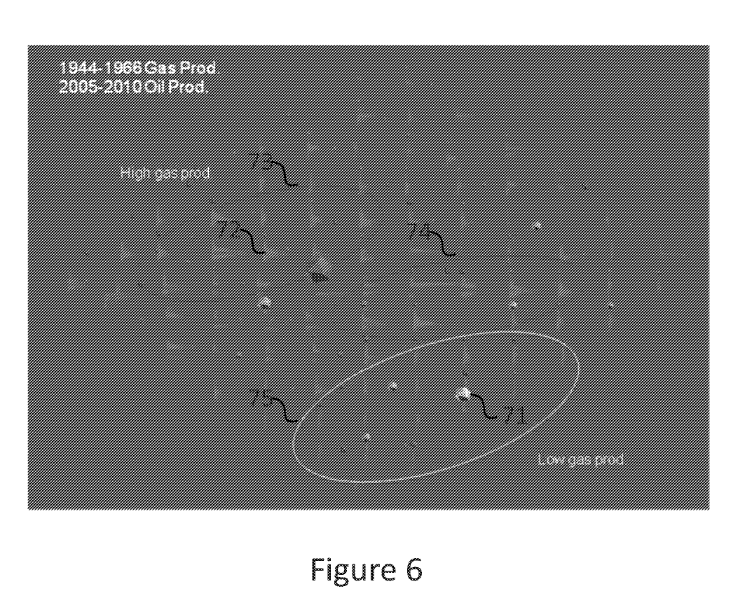

It is also possible to combine these 3D displays with conventional bubble plots as in FIG. 6 at 71. Twenty two years of early gas production are shown with a right-facing ladder display in FIG. 6 such as 72. Areas of high early gas production have been circled at 73 and 74, while an area of low gas injection has been circled at 75. The bubbles present five years of current oil production. An examination of the plot reveals that there is a general trend for high early gas production to be associated with low current oil production. This information can be used to help predict areas of remaining oil or areas where infill wells may not be particularly productive. These examples are not intended to be limiting. Any combination of the production data arranged in 3D space and combined with conventional production data displays or maps in within the scope of this invention.

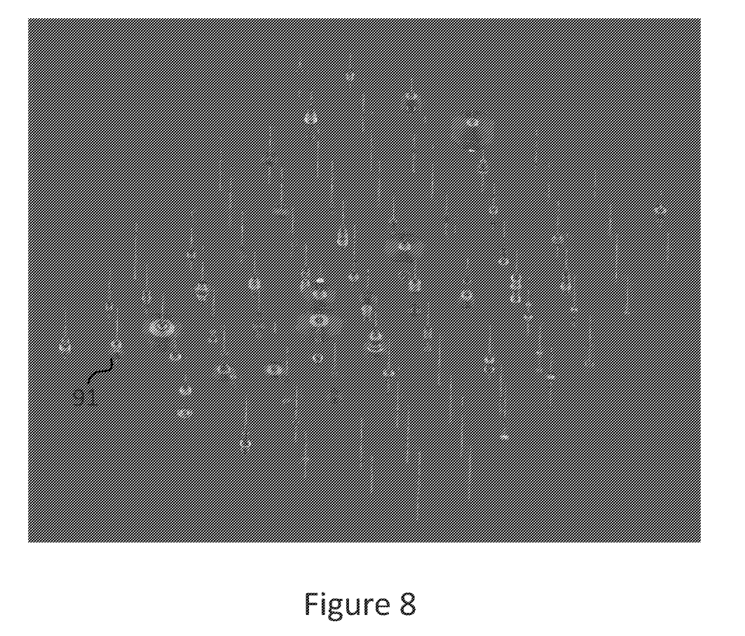

Referring again to FIG. 4, the display of well production data and/or attributes in 3D graphical space is used at step 46 to determine properties of the hydrocarbon reservoir. These properties may include, by way of example and not limitation, field wide trends, anomalies, inter-well relationships, connectivity of the hydrocarbon reservoir, and the impact of field management decisions such as injection, infill drilling, and workovers. As one skilled in the art can appreciate, these properties may be interpreted by considering the changes in the production data over all 3 dimensions and comparisons of the data between wells. FIG. 8 is a 3D representation of the GOR for a specific range of time during the production of the field. In this example, spatial changes across the field may be interpreted to suggest high stratigraphic variability.

Additionally, based on the markers on the time or pseudo-depth axis indicating significant production and injection periods for the field, it is also possible to display the data from a particular production or injection period. Such a display may be compared with another display of production data from a different period. The consideration of the data over time, particularly considering early production data in comparison with more recent data, aids in understanding stratigraphic connectivity.

Step 46 may also use log signature plots combined with maps such as FIG. 7 to help determine the stratigraphy and/or connectivity within the reservoir. In one embodiment, these displays may use maps such as KH (permeability times height of reservoir) maps, HPT (hydrocarbon pore thickness) maps, petrophysical property maps, lease maps showing production and injection patterns, connectivity maps indicating interwell connectivity, structure maps, or any other maps pertaining to field properties or field management configurations combined with the production data to help assess the sweep efficiency in various sections of the reservoir. In another embodiment, log signature maps of gas injected versus gas produced may be displayed to help assess the fault sealing capacity of faults that cut the reservoir.

The properties of the hydrocarbon reservoir are used at step 48 to make reservoir or field management decisions. These decisions may include, by way of example and not limitation, infill well placement, injection well placement, injection type, injection duration, and well conversion or shut-in. Once a new decision has been implemented, the well production data collected after the change can be added to the data in step 40 and method 400 can be repeated with the additional data.

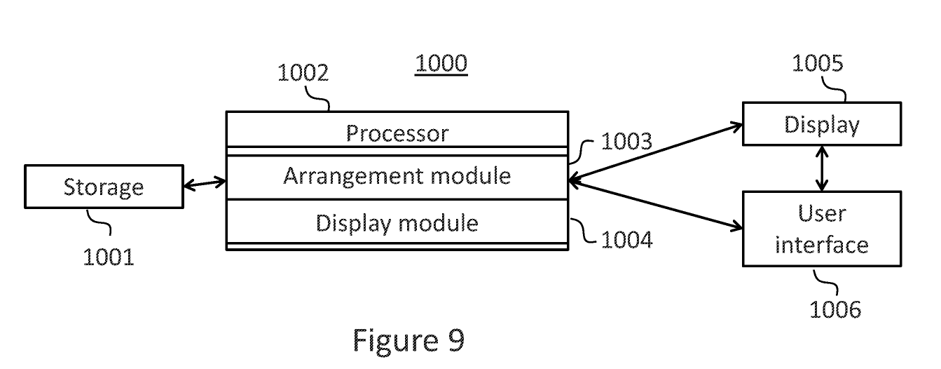

In another embodiment, method 400 of FIG. 4 may be implemented on a system 1000 in FIG. 9. The well production data may be provided to the storage unit 1001 which may be, by way of example and not limitation, a computer hard drive, a USB drive, a magnetic tape, or the like. This well production data is then provided to the processor 1002 which may be a computer microprocessor and is configured to execute computer-readable code from modules such as the arrangement module 1003, which arranges the well production data in a 3D space and may also perform additional calculations to compute production attributes, and the display module 1004, which prepares and displays the well production data in a 3D graphical display using the spatial and temporal or pseudo-depth axes and any of the lathe displays, ladder displays, bubble plots, and/or contour or geologic maps. This list of displays is not meant to be limiting; one skilled in the art will appreciate that other types of displays can be used within the scope of this invention to visualize the well production data in 3D. The display module 1004 sends the 3D well production data display to the display device 1005. The processor 1002 is in communication with both the display 1005 and the user interface 1006. The display 1005 and user interface 1006 allow the user to view the 3D well production data and to make choices to implement steps of method 400 of FIG. 4. The input from the user interface may alter or add to the 3D well production data display and that information may be stored on storage device 1001. One skilled in the art will also appreciate that processor 1002 may also execute other useful modules such as a production attributes module, an interpretation module, and the like.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method of determining properties of a hydrocarbon reservoir, comprising:
a. obtaining production data for a plurality of wells in the hydrocarbon reservoir;
b. arranging, via a computer, the production data for each of the wells such that the production data is indexed in three dimensions to create arranged production data;
c. displaying, via a computer, the arranged production data in a three dimensional graphical space to create displayed 3D production data; and
d. determining properties of the hydrocarbon reservoir based on the displayed 3D production data.

2. The method of claim 1, further comprising managing the hydrocarbon reservoir or field based on the determined properties.

3. The method of claim 2, further comprising obtaining additional production data and repeating steps b, c, and d.

4. The method of claim 2, wherein the managing the hydrocarbon reservoir includes at least one decision regarding production or injection infill well placement, type of fluid injection, location of fluid injection, fluid injection duration, adding well perforations or closing perforations, and well conversion or shut-in.

5. The method of claim 1, wherein the 3D production data is displayed as at least one lathe display.

6. The method of claim 5, wherein the lathe display uses different colors along a time or pseudo-depth axis to indicate changes in the 3D production data.

7. The method of claim 5, wherein the lathe display uses different diameters along a time or pseudo-depth axis to indicate changes in the 3D production data.

8. The method of claim 5, wherein the lathe display is combined with a bubble plot.

9. The method of claim 1, wherein the 3D production data is displayed as at least one ladder display.

10. The method of claim 9, wherein the ladder display uses different colors along a time or pseudo-depth axis to indicate changes in the 3D production data.

11. The method of claim 9, wherein the ladder display uses different bar lengths along a time or pseudo-depth axis to indicate changes in the 3D production data.

12. The method of claim 9, wherein the ladder display is posted to the right or the left of the well location to accommodate multiple production data types.

13. The method of claim 9, wherein the ladder display is combined with a bubble plot.

14. The method of claim 1, wherein the 3D production data is displayed using at least one lathe display and at least one ladder display.

15. The method of claim 1, wherein the 3D production data is displayed as at least one log signature plot overlaid on a map.

16. The method of claim 15, wherein the map is one of a KH map, a HPT map, a petrophysical property map, a lease map showing production and injection patterns, a connectivity map indicating interwell connectivity, a structure map, or any other map pertaining to field properties or field management configurations.

17. The method of claim 1, wherein the arranging of the 3D production data includes creating markers along a time or pseudo-depth axis which indicate significant production and/or injection periods.

18. The method of claim 17, wherein the displaying of the arranged production data uses a subset of data along the time or pseudo-depth axis selected based on the markers.

19. The method of claim 18, wherein at least two subsets of data are displayed and wherein the determining properties of the hydrocarbon reservoir includes assessing the effectiveness of field management decisions.

20. The method of claim 1, wherein the determining properties of the hydrocarbon reservoir includes distinguishing at least one of oil, gas, and water.

21. The method of claim 1, wherein the determining properties of the hydrocarbon reservoir includes assessing spatial and temporal or pseudo-depth trends across the displayed data to determine interwell connectivity.

22. The method of claim 21, wherein the displayed data includes production data from both infill and older wells.

23. The method of claim 1, wherein the production data includes measured data that is at least one of water production, gas production, oil production, CO2 production, water injection, gas injection, CO2 injection, and steam injection data.

24. The method of claim 23, wherein the production data further includes production attribute data that is computed based on the measured data.

25. The method of claim 24, wherein the production attribute data includes at least one of watercut data, oilcut data, total fluid, water to oil ratio (WOR), gas to oil ratio (GOR), produced oil attribute (POa), produced water attribute (PWa), produced oil water injection attribute (POWIa), water cycling attribute (WCa), oil recovery injection volume attribute (ORIVa), and voidage attribute (VOa).

26. A system for determining properties of a hydrocarbon reservoir, the system comprising:
a non-transitory data source containing computer-readable data including production data from wells drilled in or near the hydrocarbon reservoir;
a processor configured to execute computer-readable code from computer modules, the computer modules comprising:
a production data arrangement module to arrange the production data in three dimensions; and
a data display module to display the arranged production data;
a user interface in communication with the processor; and
a display device in communication with the user interface and the processor for displaying the arranged production data.

27. The system of claim 26, further comprising a production attributes module for computing production attributes from measured production data.

28. The system of claim 26, further comprising an interpretation module for interpretation of the production data in three dimensions.

29. The system of claim 26, wherein the data display module prepares the production data for display as at least one of lathe displays, ladder displays, and log signature plots overlain on a map.

30. An article of manufacture for determining properties of a hydrocarbon reservoir comprising:
a non-transitory computer readable medium having a computer readable program code embodied therein, the computer readable program code adapted to be executed to implement a method for determining properties of the hydrocarbon reservoir, the method comprising:
arranging production data representative of the hydrocarbon reservoir such that the production data is indexed in three dimensions to create arranged production data;
displaying the arranged production data in a three dimensional graphical space to create displayed 3D production data; and
determining properties of the hydrocarbon reservoir based on the displayed 3D production data.
